(19) United States
(12) Patent Application Publication
(10) Pub. No.: US 2014/0089493 A1
(43) Pub. Date: Mar. 27, 2014

(54) MINIMALLY INTRUSIVE CLOUD PLATFORM PERFORMANCE MONITORING

(71) Applicants: Eric J. Bauer, Freehold, NJ (US); Randee S. Adams, Naperville, IL (US); Mark Clougherty, Chatham, NJ (US)

(72) Inventors: Eric J. Bauer, Freehold, NJ (US); Randee S. Adams, Naperville, IL (US); Mark Clougherty, Chatham, NJ (US)

(21) Appl. No.: 13/628,817

(22) Filed: Sep. 27, 2012

(51) Int. Cl. G06F 15/173

(52) U.S. Cl. 709/224

(57) ABSTRACT

Various exemplary embodiments relate to a method for determining performance compliance of a cloud computing service implementing an application, including: receiving an application service performance requirement; receiving a cloud computing service performance requirement; receiving non-intrusive application performance data; determining that application performance does not meet the application service performance requirement based upon the received application performance data; determining that the cloud computing service provider does not meet the cloud computing service performance requirement based upon the received application service performance data; and determining that the cloud computing system not meeting the cloud computing performance requirement substantially contributes to the application performance not meeting the application service performance requirement.

### TECHNICAL FIELD

Various exemplary embodiments disclosed herein relate generally to cloud computing including the use of cloud computing in telecommunication networks.

### BACKGROUND

Many cloud operators currently host cloud services using a few large data centers, providing a relatively centralized operation. In some of these systems, a cloud consumer may request the use of one or more resources from a cloud controller which may, in turn, allocate the requested resources from the data center for use by the cloud consumer. The cloud consumer may use these cloud services to host applications, such as applications in a telecommunications network.

Typically, the cloud consumer will establish a service level agreement (SLA) with a cloud services provider. This cloud services SLA will include various service requirements that the cloud services provider is obligated to provide. Further, the cloud consumer may be providing application services over a telecommunication network, for example, to an end user. The cloud consumer and the end user may have a SLA in place that may include various service requirements that the cloud consumer is obligated to provide to the end user. Situations may arise where the cloud consumer fails to meet a service requirement of the end user SLA, and this failure may be due to the fact that the cloud services provider failed to meet a service requirement of the cloud services SLA.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for determining performance compliance of a cloud computing service implementing an application, including: receiving an application service performance requirement; receiving a cloud computing service performance requirement; receiving non-intrusive application performance data; determining that application performance does not meet the application service performance requirement based upon the received application performance data; determining that the cloud computing service provider does not meet the cloud computing service performance requirement based upon the received application service performance data; and determining that the cloud computing system not meeting the cloud computing performance requirement substantially contributes to the application performance not meeting the application service performance requirement.

Various exemplary embodiments relate to an application service monitor, including: a network interface configured to receive an application service performance requirement, a cloud service performance requirement, and non-intrusive application performance data; an application performance analyzer configured to analyze the received application performance data; and a service level agreement analyzer configured to determine that application performance does not meet the application service performance requirement based upon the received application performance data.

Various exemplary embodiments relate to method for determining performance compliance of a cloud service implementing an application, including: receiving an application services service level agreement (SLA) including an application service performance requirement; receiving a cloud service SLA including a cloud service performance requirement; receiving non-intrusive application performance data; determining that application performance does not meet the application service performance requirement based upon the received application performance data; determining that the cloud service does not meet the cloud service performance requirement; determining that the cloud service not meeting the cloud service performance requirement significantly contributes to the application performance not meeting the application service performance requirement; and sending a message indicating that the application service performance did not meet the application service performance requirement due in significant part to the cloud service not meeting the cloud service performance requirement.

### BRIEF DESCRIPTION OF THE DRAWINGS

In order to better understand various exemplary embodiments, reference is made to the accompanying drawings, wherein:

FIG. 1 illustrates an exemplary network for providing applications using a cloud platform;

FIG. 2 illustrates an exemplary application monitor; and

FIG. 3 illustrates an exemplary method for monitoring a cloud platform providing applications.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Referring now to the drawings, in which like numerals refer to like components or steps, there are disclosed broad aspects of various exemplary embodiments.

Customers expect communication applications to achieve service reliability and latency requirements that enable prompt responses to user requests. Such applications may include voice calling, voice mail, video streaming and downloading, music streaming and downloading, gaming, shopping, or the like. In order to drive down the cost of hosting and providing such applications cloud computing may be used as opposed to the use of dedicated computing hardware. The use of cloud computing allows for hardware resources to be more fully utilized and to allow for the availability of more resources when application usage is high. When a cloud service provider hosts an application in the cloud on behalf of a cloud consumer, a service level agreement (SLA) is put into place between the cloud service provider and the cloud consumer. The cloud services SLA may include various metrics that define the performance and availability of cloud resources. Examples of such performance metrics may include access latency and bandwidth/throughput of compute, disk and networking resources, including how promptly application software is executed after a timer interrupt is activated or how promptly disk or network data is available for application to process. Further, when the cloud consumer provides an application there may be a user services SLA in place between the cloud consumer and the end user. Often the metrics and expectations in the user services SLA between the cloud consumer and the end user are much more stringent than the metrics and expectation in the cloud services SLA between the cloud consumer and the cloud provider.

When virtualized applications are installed on a cloud infrastructure, the application performance is largely at the mercy of cloud scheduling performance over which the cloud consumer may have little visibility or control. This potentially puts the cloud consumer into the awkward bind of both missing service reliability and/or latency SLA metrics (and perhaps owing financial remedies) and not being able to identify the root cause(s) of the problem. As a result the cloud consumer may be unable to take appropriate (versus random) corrective actions to address the SLA breach.

While the cloud service provider may monitor their infrastructure for gross failures and other events, the cloud service provider may not have the same commercial interest in assuring that each and every cloud consumer continuously receives service that meets their SLA. Therefore, the cloud consumer may desire to monitor the performance of the cloud service provider. Traditionally, this would be clone using probes and other traditional monitoring techniques. One problem with these techniques is that they use up resources and accordingly decrease system performance. In highly tuned dedicated systems, such methods could be used because of carefully engineered performance margins built into the systems. With the implementation of applications in the cloud the use of minimally invasive monitoring techniques in order to determine the cloud and application performance is beneficial. Following are a number of examples of the types of metrics and issues that may arise, for example, in providing voice calling. It is noted that many other applications may have similar as well as different metrics which may be of interest.

One key performance metric in the implementation of voice calling is call setup latency, sometimes called post-dial delay. Examples of latency-related SLA metrics for a voice over IP (VoIP) system may include: call setup delay shall not exceed 750 msec for 99% of calls during a normal busy hour; the media cut-through delay will be less than 500 ms for 99% of calls during a normal busy hour; and the time stamps for no more than 1 in 100,000 call data records generated by the system components may be inaccurate by in excess of 150 ms. Further, there may also be reliability-related SLAs, such as the maximum number of defective transactions/failed calls, where unacceptably slow successful responses are counted as failures. As a result, unacceptably slow application performance may impact defective operations per million attempts (DPM) service reliability metrics.

In other applications, such as music or video streaming, latency may lead to problems with the quality of service (QoS) observed by a user of the application. Pixilation or drop outs may occur due to increased latency.

The cloud computing system may include a hypervisor that allocates and schedules resources for the cloud system. It should be possible to characterize overall scheduling latency performance from scheduling latency from timer events and extrapolate that to scheduling latency from network traffic, disk read, disk write or other OS events that make an application/guest OS runnable.

Applications may include a monitor or control process in each virtual machine (VM) instance hosting one or more service critical processes/components, and these monitor or control processes may have frequent and regularly scheduled events to drive heartbeating with monitored processes and other tasks. The monitor and control process may include a high availability (HA) monitor or control process. Each of these monitoring or control processes may compute the actual time interval between when scheduled events should have been executed and when they were actually run in order to assess the variability in scheduling latency (jitter). In addition, the processes may insert timestamps into regular messages (for example, heartbeat messages) that may be examined by an application monitor in order to evaluate raw latency as opposed to latency jitter. In this way, normal system operation may be monitored with minimal incremental processing load to characterize scheduling latency and jitter rather than adding dedicated monitoring tasks that may materially degrade performance by adding an additional load onto the system. Results of these non-intrusive measurements may be distilled into a latency signature that includes timestamps that may easily be collected from all VM instances along with standard performance monitoring (PM) data. This data may later be analyzed, compared, contrasted, and/or correlated to understand the probability that cloud scheduling latency contributed substantially to application latency or reliability impairments detected by the application monitor. A substantial contribution by the cloud computing system is a contribution that if removed, would allow a metric to fall within a required range.

Related to scheduling, the ability of a VM to maintain an accurate real time clock is essential for fault correlation, performance monitoring, and troubleshooting. Clock drift in the guest operating system (OS) is a known problem in virtualization. As most applications utilize a clock synchronization mechanism such as network time protocol (NTP) to maintain clock accuracy, monitoring of the statistics, such as frequency and magnitude of adjustments, may provide insight into the quality of timekeeping provided by the infrastructure. In addition, periodic comparisons of the local time with a time reference (for example, NTP server) may identify clock drift that exceeds the ability of the clock synchronization tool to correct.

In addition to scheduling latency and timing, applications may need to be concerned about whether the infrastructure is providing access to CPU resources as specified when the VM was created. This may be assessed by instrumentation of the monitoring process in which the average time taken to execute a particular block of code is measured. If the execution time is longer than the expected execution times, this may indicate that the application is not being provided its share of the host CPU cycles according to the SLA with the cloud service provider. Such measurement may not only identify short term “CPU starvation” of the application, but it may also verify longer term trends for whether the application is being provided the needed CPU resources. Because cloud service providers will focus on the overall aggregate performance rather than each and every individual VM instance, it is important to monitor individual VM instances to assure that the specific instances hosting a particular application are meeting specifications rather than relying on overall aggregate performance. This may be important in light of the fact that these performance details may vary across different host computers because of different and varying mixes of applications and user workloads across hours, days and weeks.

Although network interface performance may be harder to assess without the addition of dedicated monitoring tasks and flows, network I/O capacity and latency may be critical to the operation of most applications. If a network interface is constrained by the infrastructure, either by imposing a lower than expected throughput limit or by allowing oversubscription of the interface by virtual appliances, then the application's ability to meet its SLAs may be compromised. At a minimum, applications may monitor queue levels and packet drop statistics at all virtual egress interfaces to ensure that outgoing traffic is flowing freely through these interfaces.

FIG. 1 illustrates an exemplary network for providing applications using a cloud platform. The exemplary network may include an end user 110, an access/backhaul/wide area network 115, a cloud consumer 120, a cloud service provider 130, an application performance SLA measurement point 140, and a cloud service performance SLA measurement point 145.

The end user 110 may include any device that may use an application 122 hosted on the cloud consumer 120. The user device may be a mobile phone, tablet, computer, server, set top box, media streamer, or the like. The end user may connect to a network 115 in order to access the application 122. The network 115 may include for example an access network, a backhaul network, a wide area network, or the like.

The cloud consumer 120 may host the application 122 and may include a guest operating system (OS) 124. The application 122, for example, may include providing telephone functions, text messaging, email, music or video streaming, music or video downloading, shopping, gaming, or the like. The cloud consumer 120 may host the application 122 using a cloud service provider 130.

The cloud service 130 provider may include a hardware platform 132. The hardware platform 132 may provide computing, memory, storage, and networking. The hardware platform 132 may be an XaaS (anything as a service) platform. The cloud service provider 130 may implement the application 122 on a single hardware instance of the hardware platform 130, or may implement the application 122 across many hardware instances.

At an application performance SLA measurement point 140, the cloud consumer 120 may measure application performance relative to the application performance SLA. At a cloud service performance SLA measurement point 145, the cloud consumer 120 may measure application performance relative to the cloud service performance SLA. These measurements will be further described below.

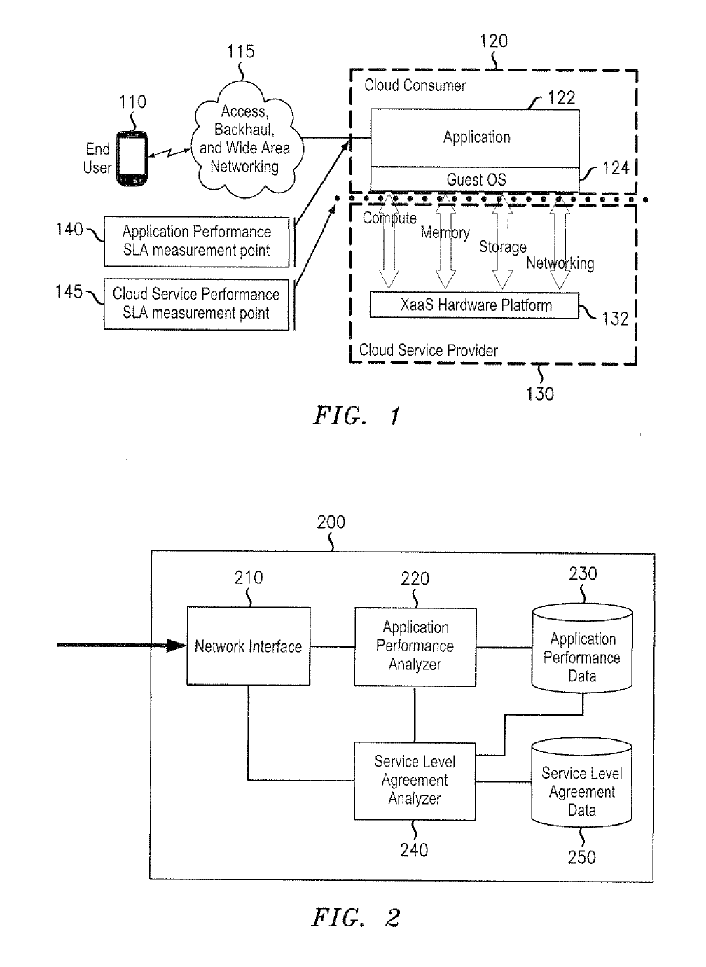

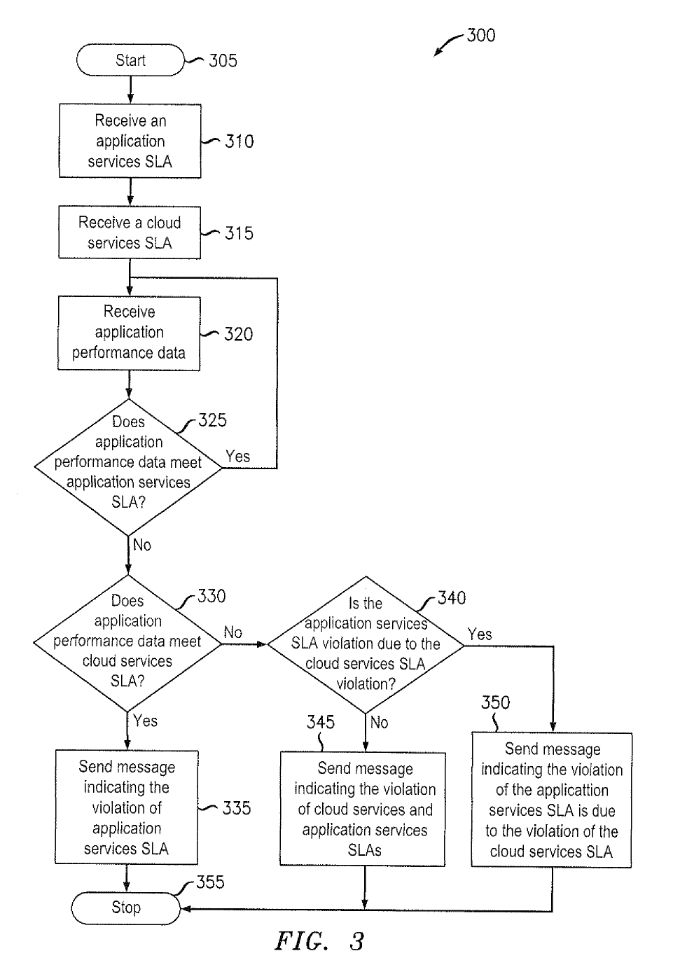

FIG. 2 illustrates an exemplary application monitor. The application monitor 200 may include a network interface 210, an application performance analyzer 220, an application performance data storage 230, a service level agreement analyzer 240, and a service level agreement data storage 250.

The network interface 210 may include one or more physical ports to interface with other networks and devices. Further, the network interface 210 may utilize a variety of communication protocols for communication over these ports. The network interface may receive various performance and monitoring information relating to applications from the cloud consumer or cloud service providers 130, 140 as well as any other devices that may collect performance and monitoring information. As discussed above, this performance and monitoring data may be collected in a non-invasive manner, without using probes or other techniques that cause a significant impact on application performance. Further, the network interface 210 may receive information related to SLAs and then may send the SLA information to the service level agreement analyzer 240 which may then store the SLA information in the service level agreement data storage 250. Alternatively, the network interface may send the SLA information directly to the service level agreement data storage 250. Such information may include application SLA information as well as cloud services SLA information.

The application performance analyzer 220 may receive performance information relating to applications from the network interface 210. Also, the application performance analyzer 220 may receive performance information relating to applications from within the application monitor 200. The application performance analyzer 220 may store the performance information in the application performance data storage 230. Further, the performance analyzer 220 may analyze and process the performance information in order to generate other performance metrics that may be used to determine compliance with application services and cloud services SLAs. The application performance analyzer 220 may also store these performance metrics in the application performance data storage 230. The application performance analyzer may analyze performance information in real-time, i.e., as it is received, as well as over time. Analysis done over time may use data collected over an extended period to determine application performance over time to identify performance trends and issues that may only become apparent over time.

For example, the application performance analyzer 220 may receive information related to scheduling latency as described above. The latency information may be derived from non-intrusive measurements. The application performance analyzer 220 may store the analyzed scheduling latency information in the application performance data storage 230 for later use by the service level agreement analyzer 240. Further, as described above, the application performance analyzer 220 may receive application performance information related to clock accuracy, access to processor resources, and network interface. For example, application performance information may include access latency to persistent storage by using a timestamp when the guest OS makes a (virtualized) disk read request and a timestamp when the requested data is returned to the guest OS. Accordingly, the observed disk latency performance may be compared with the contracted disk latency performance. Other performance information may be received, analyzed, and stored as well.

Also, the performance information received may not be directly comparable to various SLA parameters. In such situations, the application performance analyzer 220 may process the application performance information to produce application performance metrics that may be compared to SLA metrics.

The service level agreement analyzer 240 may retrieve service level agreement information and metrics from the service level agreement data storage 250. The service level agreement analyzer 240 may retrieve application performance metrics from the application performance data storage 230 for comparison to the SLA metrics. The service level agreement analyzer 240 may first determine if the application provider meets the applicable SLA metrics. If some of the application service performance metrics are not met, then the service level agreement analyzer 240 may next determine if the cloud services provider meets the applicable SLA metrics. If the cloud services provider fails to meet the cloud services SLA metrics, then the service level agreement analyzer may determine if this failure provides any basis for the application provider failing to meet its SLA metrics. If this is the case, then the service level agreement analyzer may report that the cloud service provider is a source of the failure to meet the application services SLA metrics. Accordingly, the cloud consumer may request that the cloud service provider remedy the situation. If this is not the case, then service level agreement analyzer may report that the application service provider is the source of the failure to meet the application services SLA metrics and is responsible for the remediation.

FIG. 3 illustrates an exemplary method for monitoring a cloud platform providing applications. The method 300 may be carried out by the application monitor 200. The method 300 may begin as 305. Next, the method 300 may receive an application services SLA 310. The application services SLA may be stored in the service level agreement data storage 250. The method 300 then may receive a cloud service SLA 315. The cloud services SLA may be stored in the service level agreement data storage 250. Next, the method 300 may receive application performance data 320. The application performance data may also be stored in the application performance data storage 230. Also, the application performance data may be further analyzed and processed into performance metrics.

Next, the method 300 may determine if the application performance data meets the application services SLA 325. If so, then the method returns to step 320 to further receive application performance data. If the application performance data does not meet the application services SLA, then the method determines if the application performance data meets the cloud services SLA 330. If the application performance data does meet the cloud services SLA, then the method may send a message indicating the violation of the application services SLA 335. The method may then end at 355. If not, then the method 300 may determine if the application services SLA violation is due to the cloud services SLA violation 340. If not, then the method 300 may send a message indicating the violation of the application services and cloud services SLAs 345. The method then may end at 355. If so, then the method 300 may send a message indicating the violation of the application services SLA is due to the violation of the cloud services SLA 350. The method then may end at 355.

According to the foregoing, various embodiments enable the determination if the application services SLA and the cloud services SLA are being met. Further, if they are not being met, then it may be determined if the application services SLA violation is due to the cloud services violation. If so, then the cloud consumer may seek to remedy the violations with the cloud computing services provider.

It should be apparent from the foregoing description that various exemplary embodiments of the invention may be implemented in hardware or firmware, such as for example, the application monitor, application performance analyzer, or the service level agreement analyzer. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for determining performance compliance of a cloud computing service implementing an application, comprising:
receiving an application service performance requirement;
receiving a cloud computing service performance requirement;
receiving non-intrusive application performance data;
determining that application performance does not meet the application service performance requirement based upon the received application performance data;
determining that the cloud computing service provider does not meet the cloud computing service performance requirement based upon the received application service performance data; and
determining that the cloud computing system not meeting the cloud computing performance requirement substantially contributes to the application performance not meeting the application service performance requirement.

2. The method of claim 1, wherein receiving the application service performance requirement includes receiving an application services service level agreement (SLA).

3. The method of claim 1, wherein receiving the cloud services performance requirement includes receiving a cloud SLA.

4. The method of claim 1, wherein application performance data includes at least one of application latency, cloud computing processor availability, cloud computing processor utilization, time to complete processing, disk throughput performance, network throughput performance, disk access performance, and network interface access performance.

5. The method of claim 1, further comprising sending a message indicating that the application performance does not meet the application service performance requirement when it is determined that the cloud computing system not meeting the cloud computing performance requirement substantially contributes to the application performance not meeting the application service performance.

6. The method of claim 1, further comprising analyzing the application performance data to determine application performance metrics.

7. The method of claim 6, wherein receiving the application service performance requirement includes receiving an application services SLA including metrics, and wherein determining that application service performance does not meet the application service performance requirement based upon the received application service performance data includes comparing the application performance metrics to the application services SLA metrics.

8. The method of claim 6, wherein analyzing the application performance data includes analyzing application performance data over a specified period of time.

9. An application service monitor, comprising:
a network interface configured to receive an application service performance requirement, a cloud service performance requirement, and non-intrusive application performance data;
an application performance analyzer configured to analyze the received application performance data; and
a service level agreement analyzer configured to determine that application performance does not meet the application service performance requirement based upon the received application performance data.

10. The application service monitor of claim 9, wherein the service level agreement analyzer is further configured to determine that the cloud service does not meet the cloud service performance requirement.

11. The application service monitor of claim 10, wherein the service level agreement analyzer is further configured to determine that the cloud computing system not meeting the cloud computing performance requirement substantially contributes to the application performance not meeting the application service performance requirement.

12. The application service monitor of claim 9, wherein receiving the application service performance requirement includes receiving an application services service level agreement (SLA).

13. The application service monitor of claim 9, wherein receiving the cloud service performance requirement includes receiving a cloud service level agreement.

14. The application service monitor of claim 9, wherein application performance data includes at least one of application latency, cloud computing processor availability, cloud computing processor utilization, time to complete processing, disk throughput performance, network throughput performance, disk access performance, and network interface access performance.

15. The application monitor of claim 9, wherein the application performance analyzer analyzes the application performance data over a specified period of time.

16. A method for determining performance compliance of a cloud service implementing an application, comprising:
receiving an application services service level agreement (SLA) including an application service performance requirement;
receiving a cloud service SLA including a cloud service performance requirement;
receiving non-intrusive application performance data;
determining that application performance does not meet the application service performance requirement based upon the received application performance data;
determining that the cloud service does not meet the cloud service performance requirement;
determining that the cloud service not meeting the cloud service performance requirement significantly contributes to the application performance not meeting the application service performance requirement; and
sending a message indicating that the application service performance did not meet the application service performance requirement due in significant part to the cloud service not meeting the cloud service performance requirement,
sending a message indicating that the application performance did not meet the application service performance requirement when it is determined that the cloud computing system not meeting the cloud computing performance requirement substantially contributes to the application performance not meeting the application service performance.

17. The method of claim 16, wherein application performance data includes at least one of application latency, cloud computing processor availability, cloud computing processor utilization, time to complete processing, disk throughput performance, network throughput performance, disk access performance, and network interface access performance.

18. The method of claim 16, further comprising analyzing the application performance data to determine application performance metrics.

19. The method of claim 18, wherein the application services SLA includes metrics, and wherein determining that application performance does not meet the application service performance requirement based upon the received application performance data includes comparing the application performance metrics to the services SLA metrics.

20. The method of claim 18, wherein analyzing the application performance data includes analyzing application performance data over a specified period of time.
